(19) United States
(12) Patent Application Publication
(10) Pub. No.: US 2012/0036075 A1
(43) Pub. Date: Feb. 9, 2012

(54) DETERMINING MOBILE ACCOUNT TO APPLY MARKETPLACE CHARGES

(75) Inventors: Johannes Klein, Sammamish, WA (US); Ori Bar-Niv, Seattle, WA (US); David Edward William Mercer, Bothell, WA (US); Gennady Medvinsky, Redmond, WA (US)

(73) Assignee: MICROSOFT CORPORATION, Redmond, WA (US)

(21) Appl. No.: 12/852,803

(22) Filed: Aug. 9, 2010

(51) Int. Cl. G06Q 30/00; H04L 9/32

(52) U.S. Cl. 705/64; 705/26.41

(57) ABSTRACT

Identifying a mobile operator account associated with a user to apply charges incurred by the user at a mobile marketplace service. The mobile operator provides an account identifier for the account to a billing token service associated with the mobile marketplace service. The billing token service creates a billing token including the account identifier, and provides the billing token to the user. When subsequently ordering from the mobile marketplace service, the user sends order requests with the billing token to the mobile marketplace service. The mobile marketplace service extracts the account identifier from the billing token and provides the order requests and the extracted account identifier to a mobile operator billing service. The mobile operator billing service applies a charge to the mobile operator account identified by the account identifier. Based on a charge status from the mobile operator billing service (e.g., a successful or unsuccessful charge), the mobile marketplace service allows or denies access by the user to an item identified in the order request.

### BACKGROUND

A mobile marketplace is a service that enables users to purchase digital content to be consumed on a mobile device. The content includes, for example, media content such as video, music, and images. Other content includes applications for execution on the mobile device. Users pay for the content using a credit card or other typical form of payment acceptable by other online vendors. Some existing systems charge the mobile operator account associated with the users. The users then see the charge on a bill provided by the mobile operator. The existing systems, however, rely on explicit identification of the mobile operator account to charge.

### SUMMARY

Embodiments of the disclosure enable use of an account identifier provided by a mobile operator of a network to charge orders at an application store service. The application store service receives, from a computing device via the network, an order request for an item offered by the application store service. An account identifier is extracted from the received order request. The account identifier is associated with the computing device and provided by the mobile operator of the network. The extracted account identifier is provided to a mobile operator billing service to apply a charge for the item in the received order request to an account identified by the extracted account identifier. The application store service receives a charge status from the mobile operator billing service and enables, based on the received charge status, the computing device to access the item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a mobile device communicating with a billing token service via a network of a mobile operator.

FIG. 2 is an exemplary block diagram illustrating a computing system communicating with an application store service such as a mobile marketplace service.

FIG. 3 is an exemplary flow chart illustrating operation of billing token acquisition by a computing device for placing order requests.

FIG. 4 is an exemplary flow chart illustrating billing token creation by a billing token service.

FIG. 5 is an exemplary flow chart illustrating processing of order requests by the mobile marketplace service.

FIG. 6 is an exemplary sequence diagram illustrating interaction among a mobile device, a mobile operator, a billing token service, and a mobile marketplace service.

Corresponding reference characters indicate corresponding parts throughout the drawings.

### DETAILED DESCRIPTION

Referring to the figures, embodiments of the disclosure enable determination of a mobile subscriber account to which to charge orders from a mobile marketplace service 112. Aspects of the disclosure enable creation of a billing token 207 that identifies the mobile subscriber account. A mobile device 104 or other computing device of a user 102 sends the billing token 207 as part of an order request to the mobile marketplace service 112. The mobile marketplace service 112 processes the order request by billing or otherwise applying charges to the mobile subscriber account identified in the billing token 207.

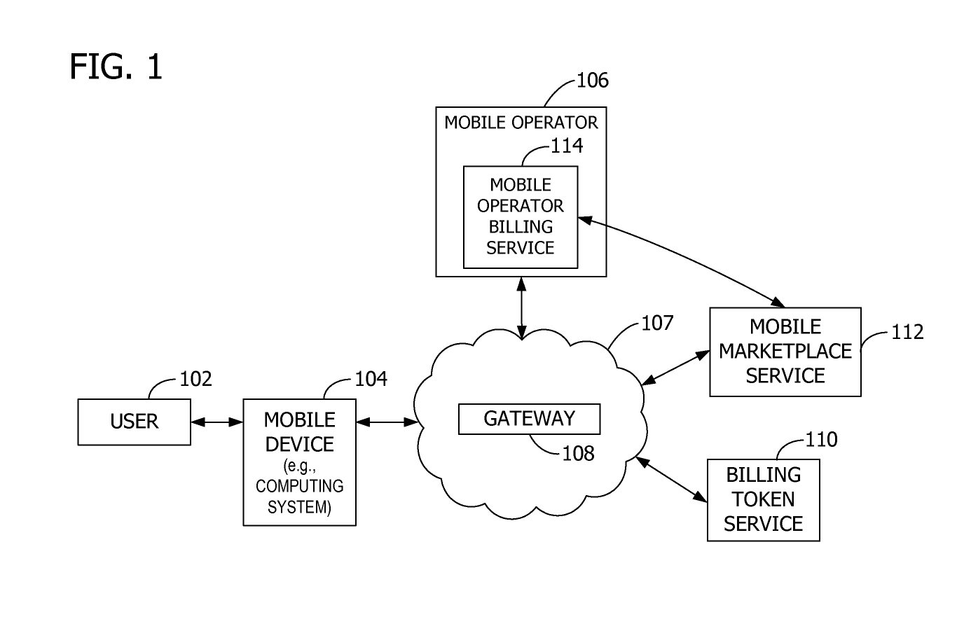

Referring again to FIG. 1, an exemplary block diagram illustrates the mobile device 104 communicating with a billing token service 110 and the mobile marketplace service 112 via a network 107 of a mobile operator 106. The mobile marketplace service 112 represents an online store, application store service 215, mobile store service, or other retail entity for ordering (e.g., purchasing, leasing, renting, etc.) items such as application programs for execution on the mobile device 104. The mobile device 104 includes any computing system that is able to establish communication with the billing token service 110 and the mobile marketplace service 112 via a network 107. The network 107 includes any wired or wireless network including, but not limited to, the Internet, a local network, a peer-to-peer connection, or a combination thereof.

Communication across the network 107 is managed by the mobile operator 106. While the mobile operator 106 may not own components of the network 107 in some embodiments, the mobile operator 106 leases or otherwise uses the network 107 to facilitate the connection between the mobile device 104 and the billing token service 110 and the mobile marketplace service 112. At least one of the components in the network 107 is a gateway 108. Further, there may be a plurality of mobile operators leasing or otherwise using the network 107.

The mobile operator, mobile service provider, or the like represents a third-party identification system separate from the mobile device 104, separate from the mobile marketplace service 112, and separate from the billing token service 110. The mobile operator provides data separate from data supplied or negotiated by the mobile device 104, the mobile marketplace service 112, and the billing token service 110. For example, the mobile operator has the ability to associate an account identifier of the user 102 of the mobile device 104 to a connection involving the mobile device 104.

A mobile operator billing service 114 is associated with the mobile operator 106. The mobile marketplace service 112 communicates with the mobile operator billing service 114 to apply charges to the mobile subscriber account of the user 102, as described herein.

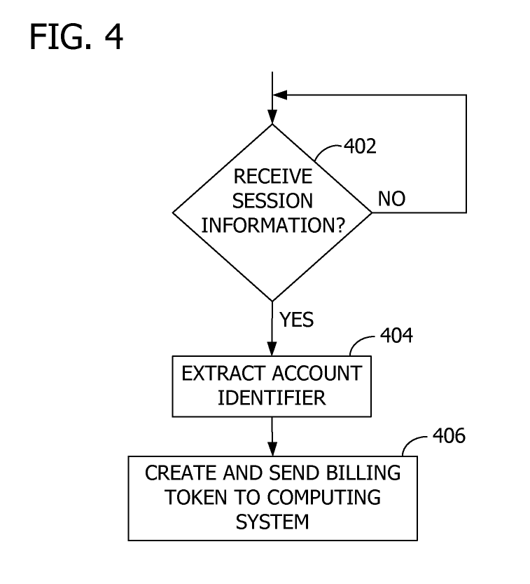

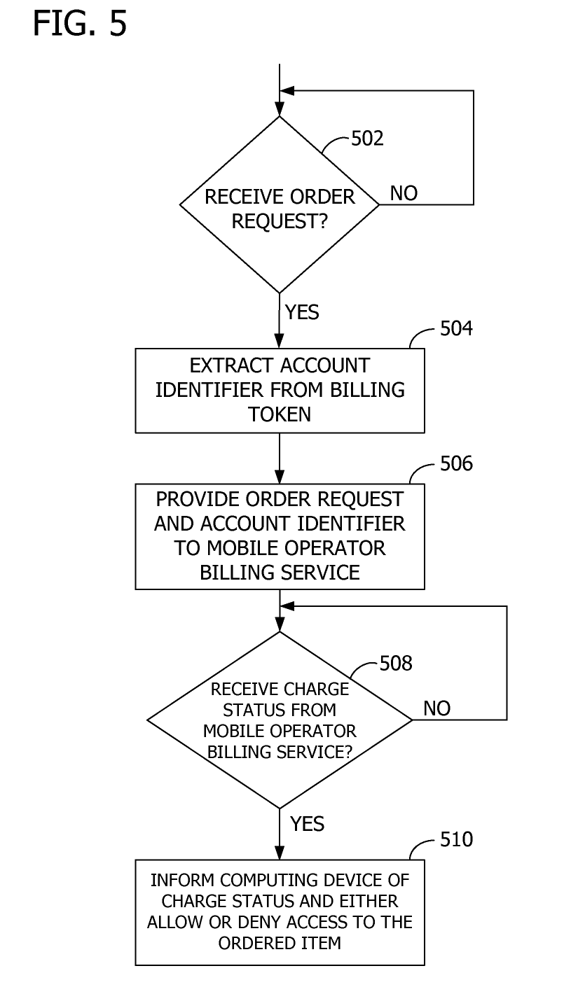

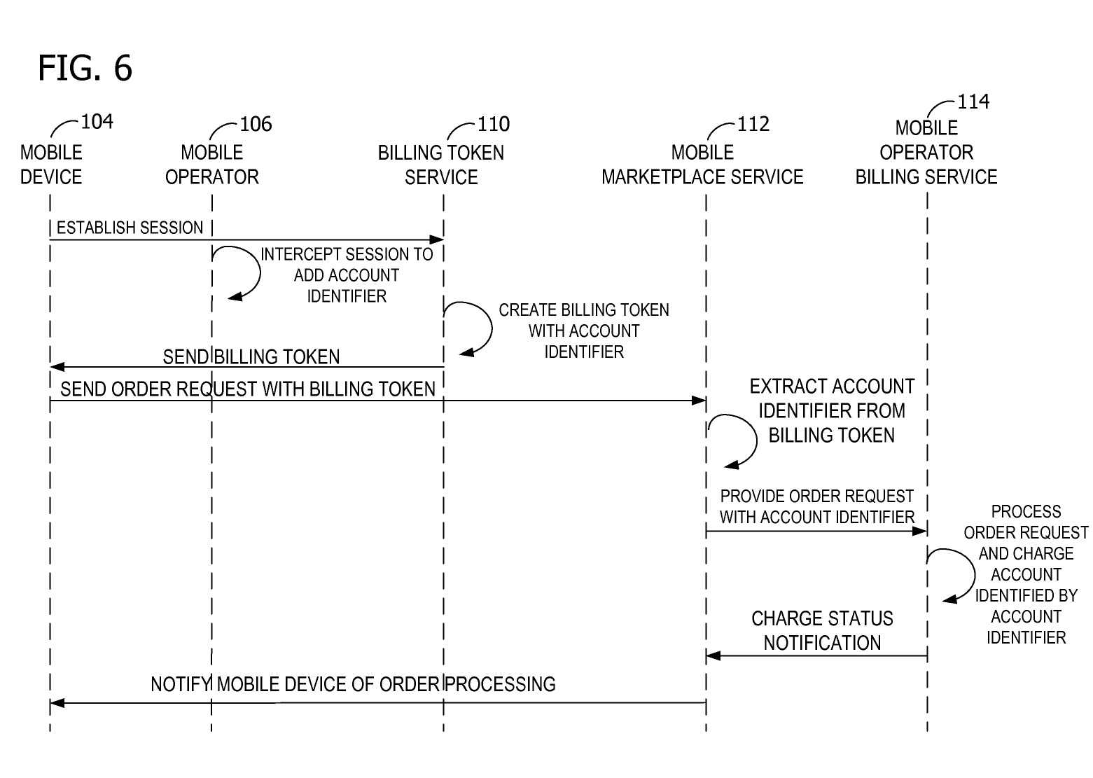

In the embodiment of FIG. 1, the billing token service 110 communicates with the mobile device 104 to provide the billing token 207. The billing token service 110 is implemented by any device executing instructions (e.g., application programs) to implement the operations and functionality described with reference to FIG. 4, FIG. 5, and/or FIG. 6 below. In some embodiments, the billing token service 110 is implemented by a server or other computing device. Further, the billing token service 110 may represent a group of processing units or group of other computing devices such as in a cloud computing environment. The billing token service 110 may be an entity separate from the mobile marketplace service 112 as shown in FIG. 1, or may be a sub-entity (not shown) that is incorporated into or otherwise associated with the mobile marketplace service 112.

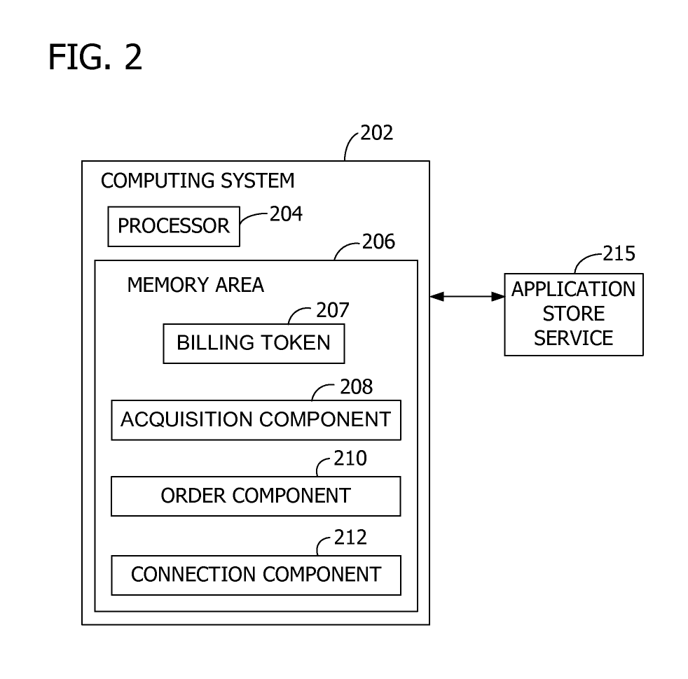

Referring next to FIG. 2, an exemplary block diagram illustrates a computing system 202 communicating with the application store service 215. The computing system 202 includes, for example, the mobile device 104 illustrated in FIG. 1. The computing system 202 represents, however, any device executing instructions (e.g., application programs) to implement the operations and functionality associated with the mobile device 104. In some embodiments, the computing system 202 includes any portable computing device such as a mobile telephone, laptop, netbook, gaming device, and/or portable media player. The computing system 202 may also include less portable devices such as desktop personal computers, kiosks, and tabletop devices. Further, the computing system 202 may represent a group of processing units or other computing devices.

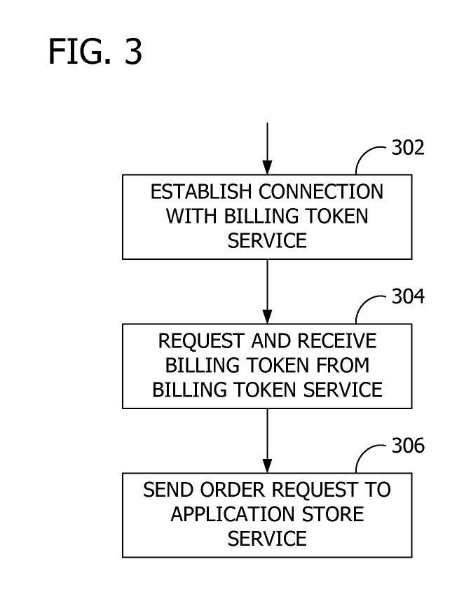

The computing system 202 has at least one processor 204. The processor 204 includes any quantity of processing units, and is programmed to execute computer-executable instructions for implementing aspects of the disclosure. The instructions may be performed by the processor 204 or by multiple processors executing within the computing system 202, or performed by a processor external to the computing system 202. In some embodiments, the processor 204 is programmed to execute instructions such as those illustrated in the figures (e.g., FIG. 3).

The computing system 202 further has one or more computer-readable media such as memory area 206. The memory area 206 includes any quantity of media associated with or accessible to the computing system 202. The memory area 206 may be internal to the computing system 202 (as shown in FIG. 2), external to the computing system 202 (not shown), or both (not shown).

The memory area 206 stores the billing token 207. The billing token 207 includes data identifying the mobile subscriber account or other account the user 102 has with the mobile operator. In some embodiments, the billing token 207 includes one or more of the following: a ciphered account identifier, a user identity, and a public key associated with a user (e.g., user 102) of the computing device.

The memory area 206 further stores one or more computer-executable components for implementing aspects of the disclosure. In particular, exemplary components include a connection component 212, an acquisition component 208, and an order component 210. The connection component 212, when executed by the processor 204, causes the processor 204 to obtain configuration information associated with the mobile operator. The connection component 212 uses the obtained configuration information to establish a connection between the computing device and the billing token service 110. The configuration information includes, for example, a location (e.g., uniform resource locator) to access to send a token request for the billing token 207. The configuration information may also specify an access point name to use to ensure that an account identifier is injected by the mobile operator into the token request or session information.

The acquisition component 208, when executed by the processor 204, causes the processor 204 to send the token request for the billing token 207 from the computing system 202 to the billing token service 110 via the connection established by the connection component 212. The token request is sent, for example, via the network 107 of the mobile operator. The token request includes a user identity associated with the user of the computing system 202. The mobile operator identifies an account identifier, subscriber billing identifier, or other billing identifier associated with the user identity, and adds, injects, inserts, or otherwise includes the account identifier with the token request. For example, the account identifier is included in a header into the token request. Alternatively or in addition, the account identifier is injected by the mobile operator into the session information that accompanies the token request. In some embodiments, the computing system 202 may send a device certificate and user identity along with the token request.

The billing token service 110 receives the token request from the computing system 202 with the included account identifier. The billing token service 110 validates the user identity in the token request. If the user identity validates successfully, the billing token service 110 generates the billing token 207 and includes the account identifier in the generated billing token 207. In some embodiments, the account identifier in the billing token 207 is opaque to the user of the computing system 202. The billing token service 110 sends the generated billing token 207 to the computing system 202. The acquisition component 208 further executes on the computing system 202 to receive the generated billing token 207 from the billing token service 110. The billing token 207 is used by the computing system 202 when sending order requests to the application store service 215 (e.g., the mobile marketplace service 112).

For example, the order component 210, when executed by the processor 204, causes the processor 204 to send the order request for an item to the application store service 215. The order request includes the billing token 207 received by the acquisition component 208. The item includes, for example, a product and/or service offered by the application store service 215. The items offered by the application store service 215 include application programs, media content, and the like. Responsive to the order request, the application store service 215 applies a charge for the item in the order request to an account identified by the account identifier in the billing token 207.

In some embodiments, the acquisition component 208, the order component 210, and the connection component 212 execute as part of an operating system associated with the computing system 202.

At least a portion of the functionality of the various elements in FIG. 2 may be performed by an entity (e.g., processor, web service, server, application program, computing device, etc.) not shown in FIG. 2.

Referring next to FIG. 3, an exemplary flow chart illustrates operation of billing token 207 acquisition by the mobile device 104 or other computing device for placing order requests. At 302, the mobile device 104 establishes a connection with the billing token service 110 via the network 107 of the mobile operator. For example, the mobile device 104 may obtain configuration information for establishing the connection via the mobile operator. The mobile operator provides the billing token service 110 with an account identifier associated with the mobile device 104. The billing token service 110 creates the billing token 207 and includes the provided account identifier in the created billing token 207.

At 304, the mobile device 104 requests and receives the billing token 207 from the billing token service 110. At 306, the mobile device 104 generates and sends an order request for one or more items to a mobile store service (e.g., the mobile marketplace service 112). The order request includes the received billing token 207, which includes the account identifier therein. The mobile store service applies a charge for the item to an account identified by the account identifier in the billing token 207.

In some embodiments, the order request is digitally signed by the mobile device 104 using a private key associated with the mobile device 104. The signing enables verification of the authenticity of the order request.

The billing token 207 may include an expiration date. In such embodiments, the mobile device 104 checks the expiration date before using the billing token 207, and requests a new billing token if billing token 207 has expired.

In some embodiments, the operations illustrated in FIG. 3 are performed by the computing system 202. In other embodiments, one or more of the operations illustrated in FIG. 3 are performed by another computing device (e.g., as a web service). Further, the operations illustrated in FIG. 3 may be implemented as software instructions encoded on a computer-readable medium, in hardware programmed or designed to perform the operations, or both.

Referring next to FIG. 4, an exemplary flow chart illustrates billing token 207 creation by the billing token service 110. If the billing token service 110 receives session information at 402, the billing token service 110 extracts the account identifier at 404. For example, the billing token service 110 receives information describing the connection between the computing system 202 (e.g., the mobile device 104) and the application store service 215. The extracted account identifier is associated with the computing system 202, and may be extracted from the session information. The session information may also include a user identity associated with the user of the computing system 202.

In some embodiments, the billing token service 110 intercepts communications between the computing system 202 and the application store service 215. The session information may be obtained from these intercepted communications. The computing system 202 and the application store service 215 may or may not be aware of the interception by the billing token service 110.

The billing token service 110 creates and sends the billing token 207 to the computing system 202 at 406. The created billing token 207 includes the extracted account identifier. In some embodiments, the created billing token 207 further includes an expiration date. The expiration date may be determined by the billing token service 110 and based on one or more of the following: a type associated with the computing system 202 (e.g., a portable device, a server, etc.), a policy set forth by the mobile operator 106, a policy of the billing token service 110, an account payment history associated with the user of the computing system 202, and the like.

In embodiments in which the session information includes the user identity, the billing token service 110 validates the user identity before creating the billing token 207. For example, if the user identity validates successfully, the billing token 207 defines security data to protect the contents of the billing token 207. The defined security data includes, for example, encryption data, digital signature data, and/or certificate data, and may be defined based on the user identity. The billing token 207 is then created or updated with the defined security data. In some embodiments, the defined security data within the billing token 207 is opaque to the computing system 202. For example, the defined security data may not be readable, decipherable, decryptable, or otherwise capable of being parsed or understood by the computing system 202.

Referring next to FIG. 5, an exemplary flow chart illustrates processing of order requests by the mobile marketplace service 112 or other marketplace service. The order requests from the computing device (e.g., the mobile device 104) include the billing token 207 associated with the computing device. If the mobile marketplace service 112 receives an order request from the computing device at 502, the mobile marketplace service 112 extracts the account identifier from the billing token 207 in the received order request at 504. The account identifier is associated with the computing device and is provided by the mobile operator 106 of the network 107. In some embodiments, the account identifier is provided by the computing device. The order request is directed to one or more items offered by the application store service 215.

In some embodiments, the mobile marketplace service 112 verifies that the billing token 207 was received from the appropriate device and is associated with the appropriate user. The verification occurs via security information included with the billing token 207.

The mobile marketplace service 112 places a charge towards an account identified by the extracted account identifier by providing the order request (including the billing token 207) and the extracted account identifier to the mobile operator billing service 114 at 506. In some embodiments, the extracted account identifier is encrypted by the mobile marketplace service 112 prior to sending to the mobile operator billing service 114. The mobile operator billing service 114 processes the order request by at least applying a charge for the item in the order request to an account identified by the extracted account identifier. For example, the account may be an account of the user with the mobile operator 106.

If the mobile marketplace service 112 receives a charge status from the mobile operator billing service 114 at 508, mobile marketplace service 112 informs the computing device of the charge status and enables the computing device to access the ordered item based on the charge status. For example, the mobile marketplace service 112 either allows or denies access by the computing device to the ordered item at 510. For example, the mobile marketplace service 112 allows the computing device to access the ordered item if the charge status indicates that the charge was successfully applied by the mobile operator billing service 114. Conversely, the mobile marketplace service 112 denies access by the computing device to the ordered item if the charge status indicates that the charge was not successfully applied by the mobile operator billing service 114.

In some embodiments, the operations illustrated in FIG. 4 and FIG. 5 are performed by the billing token service 110. In other embodiments, one or more of the operations illustrated in FIG. 4 and FIG. 5 are performed by one or more other entities (e.g., processor, web service, server, application program, computing device, etc.). Further, the operations illustrated in FIG. 4 and FIG. 5 may be implemented as software instructions encoded on a computer-readable medium, in hardware programmed or designed to perform the operations, or both.

Referring next to FIG. 6, an exemplary sequence diagram illustrates interaction among the mobile device 104, the mobile operator 106, the billing token service 110, the mobile marketplace service 112, and the mobile operator billing service 114. The mobile device 104 establishes a session with the billing token service 110. In some embodiments (not shown), the mobile device 104 establishes the session with the mobile marketplace service 112. The mobile operator 106 intercepts the session to add the account identifier of the mobile device 104 into the session information. The billing token service 110 receives the session information, and creates the billing token 207 to include the account identifier. The billing token service 110 then sends the created billing token 207 to the mobile device 104.

Subsequently, the user 102 of the mobile device 104 decides to place an order request with the mobile marketplace service 112. For example, the user 102 is browsing the mobile marketplace service 112 with the mobile device 104, and decides to purchase and download a particular application program for execution on the mobile device 104. The mobile device 104 sends an order request including the billing token 207 to the mobile marketplace service 112.

The mobile marketplace service 112 extracts the account identifier from the billing token 207, and provides the order request with the extracted account identifier to the mobile operator billing service 114. The mobile operator billing service 114 processes the order request by, among other processing operations, charging an account identified by the account identifier for the item in the order request. The mobile operator billing service 114 then notifies the mobile marketplace service 112 of the charge status (e.g., either the charge was applied successfully or unsuccessfully to the account). The mobile marketplace service 112 notifies the mobile device 104 of order processing including the charge status. For example, if the charge was successfully applied, the mobile marketplace service 112 provides the mobile device 104 with access to the ordered item via a uniform resource locator (URL).

In some embodiments, the charge status notification from the mobile operator billing service 114 also includes information regarding completion of the order, the availability of the item for shipping or downloading, etc. In other embodiments, the mobile operator billing service 114 provides the charge status to the mobile marketplace service 112 while the mobile marketplace service 112 provides other order processing information when communicating with the mobile device 104.

### Additional Examples

In some embodiments, the mobile operator 106 inserts the account identifier into a hypertext transfer protocol (HTTP) header in the session information describing the connection between the mobile device 104 and the billing token service 110. In other embodiments, the mobile operator 106 inserts the account identifier in each order request as the order request passes through the network 107.

While embodiments have been described with reference to data collected from users, aspects of the disclosure provide notice to the users of the collection of the data (e.g., via a dialog box or preference setting) and the opportunity to give or deny consent. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for generating the order request with the billing token 207 to receive the charge for the item on the account identified by the account identifier in the billing token 207, and exemplary means for providing a user identity to the mobile operator 106 to determine the account identifier.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system comprising:
a memory area for storing a billing token; and
a processor programmed to:
establish, by a mobile device, a connection with a billing token service via a network of a mobile operator, wherein the mobile operator provides the billing token service with an account identifier associated with the mobile device, and wherein the billing token service creates the billing token including the provided account identifier;
receive the billing token created by the billing token service; and
send an order request for an item to a mobile store service, said order request including the received billing token, wherein the mobile store service applies a charge for the item to an account identified by the account identifier in the billing token.

2. The system of claim 1, wherein the billing token stored in the memory area includes one or more of the following: a ciphered account identifier, a user identity, and a public key associated with a user of the mobile device.

3. The system of claim 1, wherein the processor is further programmed to obtain configuration information associated with the mobile operator, and wherein the processor is programmed to establish the connection based on the obtained configuration information.

4. The system of claim 1, wherein the processor is further programmed to sign the order request using a private key associated with the mobile device.

5. The system of claim 1, wherein the processor is further programmed to:
generate a token request;
digitally sign the generated token request with a private key associated with the mobile device; and
send the signed token request to the billing token service.

6. The system of claim 1, wherein the received billing token includes an expiration date determined based on one or more of the following: type of computing device, mobile operator policy, and account payment history.

7. The system of claim 1, further comprising means for generating the order request with the billing token to receive the charge for the item on the account identified by the account identifier in the billing token.

8. The system of claim 1, further comprising means for providing a user identity to the mobile operator to determine the account identifier.

9. A method comprising:
receiving, by an application store service from a computing device via a network, an order request for an item offered by the application store service;
extracting an account identifier from the received order request, said account identifier associated with the computing device and provided by a mobile operator of the network;
providing the extracted account identifier to a mobile operator billing service to apply a charge for the item in the received order request to an account identified by the extracted account identifier;
receiving a charge status from the mobile operator billing service; and
enabling the computing device to access the item based on the received charge status.

10. The method of claim 9, further comprising:
receiving, by a billing token service, session information describing a connection between the computing device and the application store service;
extracting, by the billing token service, the account identifier from the received session information;
creating a billing token that includes the extracted account identifier; and
sending the created billing token to the computing device, wherein the order request includes the created billing token.

11. The method of claim 10, wherein creating the billing token includes creating a billing token that includes security data.

12. The method of claim 10, further comprising determining an expiration date for the created billing token based on one or more of the following: type of computing device, mobile operator policy, and account payment history.

13. The method of claim 12, wherein creating the billing token includes creating a billing token that includes the determined expiration date.

14. The method of claim 10, wherein the session information includes a user identity associated with a user of the mobile device, and wherein creating the billing token includes:
validating the user identity;
defining security data based on the validated user identity; and
creating the billing token to include the defined security data, wherein the defined security data within the billing token is opaque to the computing device.

15. The method of claim 9, further comprising encrypting the extracted account identifier.

16. The method of claim 9, further comprising establishing a connection with the computing device to receive the order request.

17. One or more computer-readable media having computer-executable components, said components comprising:
an acquisition component that when executed by at least one processor causes the at least one processor to send a token request for a billing token from a computing device to a billing token service via a network of a mobile operator, said token request having a user identity included therein, wherein the mobile operator adds an account identifier associated with the user identity to the token request, and wherein the billing token service validates the user identity in the token request and generates the billing token to include the account identifier, wherein the acquisition component further receives the generated billing token from the billing token service; and
an order component that when executed by at least one processor causes the at least one processor to send an order request for an item to an application store service, said order request including the billing token received by the acquisition component, wherein the application store service applies a charge for the item to an account identified by the account identifier in the billing token.

18. The computer-readable media of claim 17, further comprising a connection component that when executed by at least one processor causes the at least one processor to obtain configuration information associated with the mobile operator, and wherein the connection component establishes a connection between the computing device and the billing token service and between the computing device and the application store service.

19. The computer-readable media of claim 17, wherein the billing token includes one or more of the following: a ciphered account identifier, a user identity, and a public key associated with a user of the computing device.

20. The computer-readable media of claim 17, wherein the account identifier in the billing token is opaque to a user of the computing device.
